(19) United States
(12) Patent Application Publication
(10) Pub. No.: US 2026/0301500 A1
(43) Pub. Date: Oct. 1, 2026

(54) MONEY STORAGE DEVICE, MONEY HANDLING MACHINE, AND MONEY HANDLING METHOD

(71) Applicant: Glory Ltd., Himeji-shi (JP)

(72) Inventors: Yusuke YOSHIDA, Himeji-shi (JP); Takumi ITO, Himeji-shi (JP)

(73) Assignee: Glory Ltd., Himeji-shi (JP)

(21) Appl. No.: 19/578,939

(22) Filed: Mar. 26, 2026

(30) Foreign Application Priority Data
Mar. 28, 2025 (JP) 2025-056311

(51) Int. Cl. G07D 9/00; G07D 11/10

(52) U.S. Cl. CPC G07D 9/008; G07D 11/10; G07D 2201/00

(57) ABSTRACT

A money storage device includes: a housing including a first storage space; a second storage unit forming a second storage space independent of the first storage space; and an endless transport belt that transports money stored in the first storage space to an exit of the housing. The transport belt revolves in a vertical plane along the inner wall of the housing that surrounds the first storage space. The second storage unit is inside a belt path of the transport belt, and discharges money stored in the second storage space into the housing. The transport belt transports the money discharged from the second storage unit to the exit.

### CROSS-REFERENCE TO RELATED APPLICATION

This application claims priority to Japanese Patent Application No. 2025-056311, filed on Mar. 28, 2025, the entire disclosures of which are incorporated herein by reference.

### BACKGROUND

A conventional money handling machine includes a storage container for coins. The storage container stores a mixture of coins of a plurality of denominations. A lower portion of the storage container has an exit opening. The coins stored in the storage container are discharged from the exit opening to the outside of the storage container.

The conventional money handling machine includes a conveyor. The conveyor is in the form of a loop that surrounds the storage container. The conveyor receives the coins discharged from the exit opening to the outside of the storage container. The conveyor transports the coins to a recognition unit outside the storage container. The recognition unit is positioned to correspond to an upper portion of the storage container.

The conveyor further discharges the coins that have passed through the recognition unit to one selected from a plurality of exit gates in accordance with the recognition result.

The conventional money handling machine further includes a coin reservoir separate from the storage container. The coin reservoir is located inside the conveyor, and is connected to one of the exit gates. The conventional money handling machine can store, in the coin reservoir, the coins discharged from the storage container.

Coins discharged from the coin reservoir are supplied to the conveyor.

### SUMMARY

The technique disclosed herein relates to a money storage device. The money storage device includes:
a housing including a first storage space in which money is stored;
a second storage unit that is located in the housing and that forms a second storage space independent of the first storage space; and
an endless transport belt that transports the money stored in the first storage space to an exit of the housing.

The transport belt revolves in a vertical plane along an inner wall of the housing that surrounds the first storage space in the housing.

The second storage unit is inside a belt path of the transport belt, and discharges money stored in the second storage space into the housing.

The transport belt transports the money discharged from the second storage unit to the exit.

### BRIEF DESCRIPTION OF THE DRAWINGS

FIG. 1 illustrates a money handling machine.

FIG. 2 illustrates an internal structure of a money storage device.

FIG. 3 is a cross-sectional view of the money storage device.

FIG. 4 is a cross-sectional view of the money storage device.

FIG. 5 is a perspective view of a transport belt.

FIG. 6 illustrates transport of money during depositing.

FIG. 7 illustrates transport of money during dispensing.

FIG. 8 illustrates transport of money during depositing in a situation where a second storage unit is used as a temporary storage unit.

FIG. 9 illustrates transport of money during depositing in a situation where the second storage unit is used as the temporary storage unit.

FIG. 10 illustrates transport of money during depositing in a situation where the second storage unit is used as the temporary storage unit.

FIG. 11 illustrates transport of money in circulation transport during depositing.

FIG. 12 illustrates transport of money in circulation transport during dispensing.

FIG. 13 illustrates an external appearance of a front portion of the money handling machine.

FIG. 14 illustrates a cross section taken along line A-A in FIG. 13 in an upper portion, and illustrates a cross section taken along line B-B in FIG. 13 in a lower portion.

FIG. 15 illustrates a communication opening formed in a side wall of a housing of the money storage device.

FIG. 16 illustrates a variation of a depositing unit of the money handling machine.

### DETAILED DESCRIPTION

A conventional money handling machine is a large-sized machine for use on the floor. In contrast, a desktop money handling machine for use on a fixture such as a counter, a table, or a desk is required to be compact. In order not to impair operability, such a desktop machine, in particular, needs to have its overall height lowered.

As is the case with the conventional money handling machine, the money storage device or money handling machine including two types of storage spaces such as a first storage space and a second storage space independent of each other tends to increase in size when the amount of money to be stored is increased.

The technique disclosed herein miniaturizes a money storage device having two types of storage spaces such as a first storage space and a second storage space independent of each other.

The technique disclosed herein relates to a money storage device. The money storage device includes:
a housing including a first storage space in which money is stored;
a second storage unit that is located in the housing and that forms a second storage space independent of the first storage space; and
an endless transport belt that transports the money stored in the first storage space to an exit of the housing, and
the transport belt revolves in a vertical plane along an inner wall of the housing that surrounds the first storage space in the housing.

The second storage unit is inside a belt path of the transport belt, and discharges money stored in the second storage space into the housing.

The transport belt transports the money discharged from the second storage unit to the exit.

The endless transport belt transports the money stored in the first storage space to the exit of the housing inside the housing. The transport belt constitutes a discharge mechanism that discharges money in the housing to the outside of the housing.

The transport belt revolves in a vertical plane along the belt path that surrounds the first storage space. In other words, the first storage space is formed inside the looped belt path.

The belt path is along the inner wall of the housing. The belt path is designed to extend in the upward/downward direction and in the horizontal direction inside the housing to the extent possible. Such extension of the loop forming the belt path can enlarge the first storage space. This allows the money storage device to have a sufficiently large capacity even if the housing is compact.

The second storage unit in the housing forms the second storage space independent of the first storage space. The money storage device includes two types of storage spaces. The two types of storage spaces independent of each other allow the money handling machine including the money storage device to smoothly handle money while enabling storage of a sufficiently large amount of money.

Since the second storage unit is inside the enlarged belt path, the size of the housing is not increased. There is no need to provide a sufficiently large space for the second storage unit outside the money storage device in the money handling machine.

The transport belt further transports the money discharged from the second storage unit to the exit. The discharge mechanism is used to transport money from both the first storage space and the second storage space.

The exit may be located in an upper portion of the housing, and
the transport belt may transport money from a bottom portion of the housing to the exit.

The money in the first storage space is accumulated on the bottom portion of the housing under its own weight. The money discharged from the second storage unit is also accumulated on the bottom of the housing.

The transport belt transports money from the bottom portion of the housing to the exit in the upper portion of the housing. The money is discharged to the outside of the housing through the exit located in the upper portion of the housing.

The belt path may include a first path extending along a bottom of the housing,
the money stored in the first storage space may be supplied on the transport belt in the first path, and
the second storage unit may have an openable/closable discharge port, which is opened to discharge the money stored in the second storage space on the transport belt in the first path.

The money storage device can discharge the money stored in the first storage space and the money stored in the second storage space separately to the outside of the housing.

The first storage space and the second storage space may be arranged in a direction along the first path.

The two storage spaces arranged in the horizontal direction can lower the overall height of the money storage device. The overall height of the money handling machine including the money storage device can also be lowered.

The money storage device may further include: a second transport belt that is located in the first storage space and is configured to transport money stored in the first storage space toward the transport belt in the first path.

Cooperation between the second transport belt and the transport belt allows the money stored in the first storage space to be smoothly transported to the exit and to be discharged to the outside of the housing.

The money storage device may further include: a shutter that is located between the transport belt and the second transport belt and is configured to limit an amount of money to be supplied from the first storage space to the transport belt.

The amount of money to be discharged from the housing of the money storage device can be adjusted by the shutter. The money storage device can change, for example, the amount of money to be discharged during a change replenishment process for replenishing the second storage unit with money and the amount of money to be discharged during a collection process for collecting money in the first storage space.

The belt path may include a second path that is continuous with the first path and that reaches an upper portion of the housing from the bottom portion of the housing along a vertical one of the inner wall of the housing.

The second path transports money vertically or substantially vertically along the vertical inner wall of the housing. Money is rapidly transported from the bottom portion to the upper portion of the housing through the transport belt.

The transport belt may include a pin arranged at intervals in a travel direction of the belt, the pin being configured to engage with money.

The transport belt can stably transport money even through the vertical or substantially vertical belt path using a simple structure that allows money to be engaged with the pin.

A motor that causes the transport belt to travel may be inside the belt path.

Since the motor is located inside the belt path, the belt path can be brought closer to the inner wall of the housing. The belt path brought closer to the inner wall enlarges the first storage space.

The motor may be inside the belt path and above the second storage unit.

The motor is located relatively above inside the belt path. When the motor is located above, a portion of the interior of the housing below the motor can be used as the first storage space or as the second storage unit that forms the second storage space.

In other words, the motor is located in a space that is hardly used to store money inside the belt path. Thus, the motor is placed without reducing the first storage space of the money storage device. The space efficiency of the money storage device is improved.

The first storage space may store money of a plurality of denominations, and
the second storage space may store money of a plurality of denominations.

Since the money storage device does not store money of different denominations separately, the money storage device with a small size can also have its capacity increased.

A money handling machine disclosed herein includes the above-described money storage device.

Since the money storage device is compact even with a large capacity, it is advantageous for downsizing the money handling machine.

The money handling machine may further include:
a transport unit that is located above the money storage device and that transports money;
a feeding unit that is connected to the transport unit and feeds out held money one by one to the transport unit;
a recognition unit that is located at an intermediate position of a transport path of the transport unit and recognizes the money fed out from the feeding unit; and
a diverter that is located at an intermediate position of the transport path and changes a transport destination of money that has passed through the recognition unit in accordance with a recognition result.

Money discharged out of the housing from the exit of the housing through the transport belt of the money storage device may be sent to the feeding unit.

The transport path is above the money storage device.

A downstream end of the transport path may be connected to the first storage space.

The transport path may be a one-way transport path from the feeding unit to the money storage device.

The recognition unit is located at an intermediate position of the transport path, and thus can recognize the money discharged from the money storage device and fed out from the feeding unit.

The diverter can selectively determine a transport destination of the money recognized by the recognition unit. The diverter may send money to the first storage space. The diverter may send money to the second storage unit. The diverter may send money to the dispensing unit that ejects money to the outside of the machine.

During a dispensing process in which money is ejected to the dispensing unit, the money storage device may discharge the money stored in the second storage space out of the housing, and
the diverter may selectively send money to be dispensed, out of money in the second storage unit, to the dispensing unit.

The second storage unit may store money of a previously designated one or more of a plurality of denominations by a designated number of money.

The second storage unit may store part of the money discharged from the first storage space.

The second storage unit may store, for example, money to be dispensed as change by the money handling machine.

The second storage unit may store a minimum set of money serving as change.

If the second storage unit stores the change to be dispensed to the outside of the machine, the money stored in the first storage space of the money storage device is not used for the dispensing process. There is no demand to rapidly discharge money of a predetermined denomination from the first storage space. The first storage space can store a mixture of money of a plurality of denominations. Such a mixture storage can increase the capacity of the first storage space.

During a depositing process in which money is stored in the first storage space, the second storage unit may discharge stored money stored in the second storage space into the housing of the money storage device,
while the feeding unit feeds out deposited money inserted into the money handling machine during the depositing process to the recognition unit, the diverter may send the deposited money that has been recognized to the second storage unit, and
the second storage unit temporarily stores the deposited money.

The second storage unit can be used as a temporary storage unit that temporarily stores the deposited money during the depositing process. The stored money that has been stored in the second storage unit is discharged into the housing of the money storage device, thereby preventing mixing of the deposited money and the stored money.

In response to an operation for confirming a depositing process, the transport belt of the money storage device may transport the stored money discharged from the second storage unit to the exit of the housing to send the stored money to the feeding unit,
after the stored money is sent to the feeding unit, the second storage unit may discharge the deposited money stored in the second storage space into the housing,
while the feeding unit feeds out the stored money to the recognition unit, the diverter may return the stored money that has been recognized to the second storage unit,
after the stored money is returned to the second storage unit, the transport belt may transport the deposited money discharged from the second storage unit to the exit of the housing to send the deposited money to the feeding unit, and
while the feeding unit feeds out the deposited money to the recognition unit, the diverter may send the deposited money that has been recognized to the first storage space.

If the second storage unit is used as the temporary storage unit, a user performing an operation for confirming the depositing process allows the deposited money to be stored in the first storage space. The stored money and the deposited money moving sequentially among the money storage device, the feeding unit, the recognition unit, and the diverter allows the stored money to be again stored in the second storage unit, and allows the deposited money to be stored in the first storage space.

In response to an operation for cancelling a depositing process, the transport belt of the money storage device may transport the stored money discharged from the second storage unit to the exit of the housing to send the stored money to the feeding unit,
after the stored money is sent to the feeding unit, the second storage unit may discharge the deposited money stored in the second storage space into the housing,
while the feeding unit feeds out the stored money to the recognition unit, the diverter may return the stored money that has been recognized to the second storage unit,
after the stored money is returned to the second storage unit, the transport belt may transport the deposited money discharged from the second storage unit to the exit of the housing to send the deposited money to the feeding unit, and
while the feeding unit feeds out the deposited money to the recognition unit, the diverter may send the deposited money to a dispensing unit that dispenses money out of the machine.

If the second storage unit is used as the temporary storage unit, the user performing an operation for cancelling the depositing process allows the deposited money to be sent to the dispensing unit. The stored money and the deposited money move sequentially among the money storage device, the feeding unit, the recognition unit, and the diverter, then the stored money is again stored in the second storage unit, and the deposited money is sent to the dispensing unit.

A money handling method disclosed herein includes:
transporting money stored in a first storage space in a housing of a money storage device to an exit of the housing through a transport belt in the housing, and discharging the money from the housing;
sending, by a feeding unit, the money discharged from the housing one by one to a recognition unit, and recognizing, by the recognition unit, the money;
sending a designated number of money of a previously designated one or more of denominations to a second storage space of a second storage unit in the housing, based on a recognition result, to store the money in the second storage unit;
discharging all the money stored in the second storage unit into the housing under a dispensing instruction, and transporting, by the transport belt, the money to the exit to discharge the money from the housing;
sending, by the feeding unit, the money discharged from the housing one by one to the recognition unit, and recognizing, by the recognition unit, the money; and
selectively sending money to be dispensed to a dispensing unit, based on a recognition result.

In the money handling method,
during a depositing process in which money is stored in the first storage space, the second storage unit may discharge stored money stored in the second storage space into the housing, and
while the feeding unit feeds out deposited money inserted into the money handling machine during the depositing process to the recognition unit, the diverter may send the deposited money that has been recognized to the second storage unit.

In the money handling method,
in response to an operation for confirming a depositing process, the transport belt may transport the stored money discharged into the housing to the exit of the housing to send the transported stored money to the feeding unit,
after the stored money is sent to the feeding unit, the second storage unit may discharge the deposited money stored in the second storage space into the housing,
while the feeding unit feeds out the stored money to the recognition unit, the diverter may return the stored money that has been recognized to the second storage unit,
after the stored money is returned to the second storage unit, the transport belt may transport the deposited money discharged into the housing to the exit of the housing to send the transported deposited money to the feeding unit, and
while the feeding unit feeds out the deposited money to the recognition unit, the diverter may send the deposited money that has been recognized to the first storage space.

In the money handling method,
in response to an operation for cancelling a depositing process, the transport belt may transport the stored money discharged into the housing to the exit of the housing to send the transported stored money to the feeding unit,
after the stored money is sent to the feeding unit, the second storage unit may discharge the deposited money stored in the second storage space into the housing,
while the feeding unit feeds out the stored money to the recognition unit, the diverter may return the stored money that has been recognized to the second storage unit,
after the stored money is returned to the second storage unit, the transport belt may transport the deposited money discharged into the housing to the exit of the housing to send the transported deposited money to the feeding unit, and
while the feeding unit feeds out the deposited money to the recognition unit, the diverter may send the deposited money to a dispensing unit that dispenses money out of the machine.

Embodiments of a money storage device, a money handling machine, and a money handling method will be described below with reference to the drawings. The money storage device, the money handling machine, and the money handling method described here are examples.

### Money Handling Machine

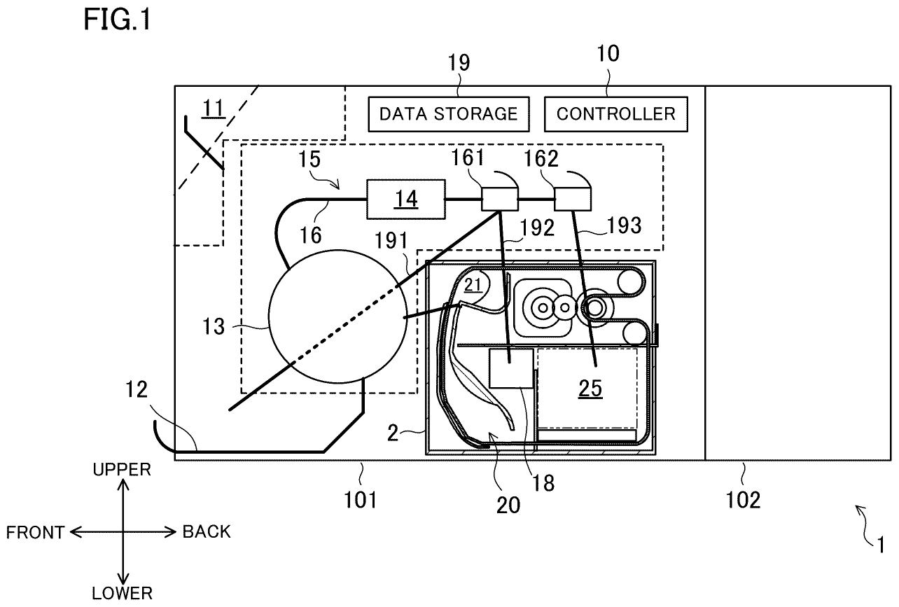

FIG. 1 illustrates a money handling machine 1. The money handling machine 1 is a coin handling machine configured to handle coins.

For description of the money handling machine 1, the terms “front,” “back,” “left,” “right,” “upper,” and “lower” as used herein are defined as follows. The front side of the money handling machine 1 is set to correspond to the left side of the paper plane of FIG. 1, and the back side of the money handling machine 1 is set to correspond to the right side of the paper plane of FIG. 1. The front side of the money handling machine 1 is a side on which a depositing unit 11 or a dispensing unit 12 to be described later is located, and the back side of the money handling machine 1 is a side opposite thereto.

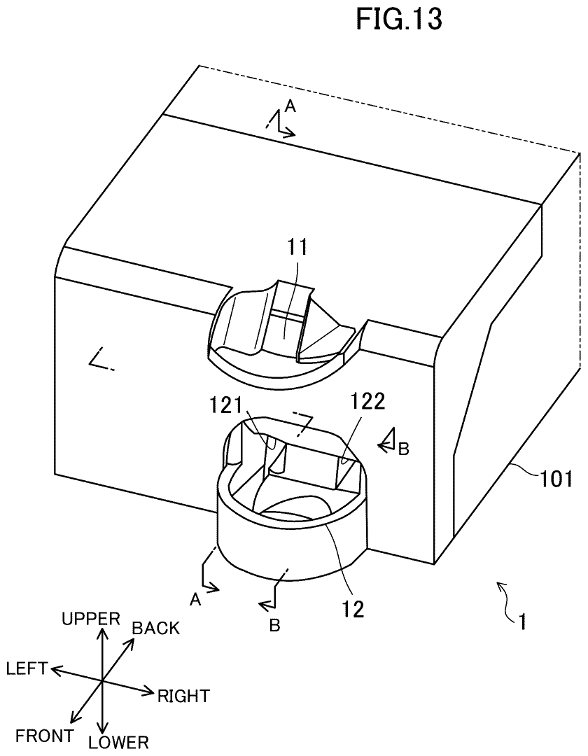

The left side of the money handling machine 1 is set to correspond to the left side of a user who faces the front side of the money handling machine 1, and the right side of the money handling machine 1 is set to correspond to the right side of the user (see also FIG. 13).

The upper side of the money handling machine 1 is set to correspond to the upper side of the paper plane of FIG. 1, and the lower side of the money handling machine 1 is set to correspond to the lower side of the paper plane of FIG. 1. The upper and lower sides of the money handling machine 1 correspond to the upper and lower sides, respectively, of the money handling machine 1 placed on a fixture, for example.

The terms “front,” “back,” “left,” “right,” “upper,” and “lower” to be used in the following description are used only for description of the money handling machine 1. The terms “front,” “back,” “left,” “right,” “upper,” and “lower” to be used in the following description are not used to limit the structure of the money handling machine 1.

The money handling machine 1 is installed in, for example, a store, and is used to settle a transaction between the store and a customer. The money handling machine 1 is combined with another money handling machine that handles banknotes and an input/output device. The input/output device provides information to the customer and accepts a customer's operation. The input/output device is, for example, a touch panel display. The input/output device may be installed on the money handling machine 1.

A user of the money handling machine 1 is mainly a customer of the store. The customer uses the money handling machine 1 to pay for a product or products purchased from the store and/or service offered from the store.

A staff member of the store may operate the money handling machine 1 to manage the money handling machine 1.

The money handling machine 1 executes a process for depositing and/or dispensing coins. The process for depositing coins is the process of storing coins paid by the customer (deposited coins) in the money handling machine 1. The process for dispensing coins is the process of dispensing coins as change (dispensed coins) out of the money handling machine 1.

The money handling machine 1 includes the depositing unit 11. The depositing unit 11 sends a coin(s) inserted thereinto by a customer to a feeding unit 13 to be described later. The depositing unit 11 includes a shutter, and when the shutter is open, the customer can insert a coin(s) into the depositing unit 11. When the shutter is closed, the customer cannot insert a coin(s) into the depositing unit 11.

The money handling machine 1 includes the dispensing unit 12. The dispensing unit 12 holds one or more coins dispensed to the customer. The customer manually removes the one or more coins from the dispensing unit 12.

The money handling machine 1 includes the feeding unit 13. The feeding unit 13 is located inside the money handling machine 1. The feeding unit 13 functions to temporarily hold coins and to feed out the held coins one by one. The feeding unit 13 may be, for example, a rotary-disk feeding unit 13 including a rotary disk. The feeding unit 13 is connected to the depositing unit 11. The feeding unit 13 is also connected to a transport unit 15. The feeding unit 13 feeds out coins one by one to the transport unit 15 to send the fed coins to a recognition unit 14. The feeding unit 13 is connected also to a storage 2 to be described later.

The money handling machine 1 includes the recognition unit 14 on a transport path 16 of the transport unit 15. The coins fed out from the feeding unit 13 are transported by the transport unit 15, and pass through the recognition unit 14. The recognition unit 14 recognizes the denominations of the coins passing therethrough. The recognition unit 14 may further recognize the authenticity and fitness of the coins. The recognition unit 14 includes at least one of an optical sensor, such as a line sensor or a camera, or a magnetic sensor.

The money handling machine 1 includes the transport unit 15. The transport unit 15 transports coins inside the money handling machine 1. The transport unit 15 has the transport path 16. The coins are transported along the transport path 16. The transport path 16 passes from the feeding unit 13 through the recognition unit 14. A downstream end of the transport path 16 is connected to a first storage space 25 of the storage 2 to be described later. The transport path 16 is not in the form of a loop, and does not have a folded portion. Thus, the overall height of the money handling machine 1 is lowered.

The transport unit 15 includes a first gate 161. The first gate 161 is located on the transport path 16. The first gate 161 selectively sends the coins that have passed through the recognition unit 14 to the dispensing unit 12, to the second storage unit 18, or to a second gate 162. A first chute 191 connects the first gate 161 and the dispensing unit 12 together. A second chute 192 connects the first gate 161 and the second storage unit 18 together.

The transport unit 15 includes the second gate 162. The second gate 162 is located at the downstream end of the transport path 16. The second gate 162 sends the coins that have passed through the recognition unit 14 to the first storage space 25 of the storage 2. When the second gate 162 opens, the coins are conveyed to the first storage space 25. A third chute 193 connects the second gate 162 and the first storage space 25 together. A diverter of the transport unit 15 including the first gate 161 and the second gate 162 changes a transport destination of the coins to be transported.

The money handling machine 1 includes the storage 2. The storage 2 is an example of the money storage device.

The storage 2 is mounted inside a housing of the money handling machine 1. The storage 2 stores coins in the first storage space 25. The storage 2 stores a mixture of coins of a plurality of denominations. The phrase “store(s) a mixture of . . . ” as used herein means that the coins are not stored by denomination.

The storage 2 is located in a lower portion of the interior of the housing of the money handling machine 1. The transport path 16 and the recognition unit 14 are located above the storage 2.

The storage 2 is located below the second gate 162. Coins drop from the second gate 162 to the storage 2 through the third chute 193 extending in an upward/downward direction inside the housing of the money handling machine 1. The dropped coins are stored in the first storage space 25.

The money handling machine 1 includes the second storage unit 18. The second storage unit 18 is located inside the storage 2. The second storage unit 18 forms a second storage space independent of the first storage space 25.

The second storage unit 18 stores a mixture of coins of a plurality of denominations. The second storage unit 18 has a smaller capacity than the first storage space 25 does.

The second storage unit 18 is located below the first gate 161. Coins drop from the first gate 161 to the second storage unit 18 through the second chute 192 extending in the upward/downward direction inside the housing of the money handling machine 1. The dropped coins are stored in the second storage unit 18.

The storage 2 further includes a discharge mechanism 20. As will be described later, the discharge mechanism 20 discharges the coins stored in the storage 2 to the outside of the storage 2 through an exit 21 of the storage 2. The coins discharged to the outside of the storage 2 are sent to the feeding unit 13. The feeding unit 13 faces an upper portion of the storage 2.

The structure of the storage 2 will be described in detail later.

The money handling machine 1 includes a controller 10. The controller 10 outputs a control signal to components of the money handling machine 1 to control functions and operations of the components. For example, a program adapted to the controller 10 is stored in a dedicated memory in advance, and is then executed by hardware, such as a central processing unit (CPU), thereby achieving the functions and operations of the controller 10. The controller 10 controlling the components enables various processes executed by the money handling machine 1.

According to an exemplary embodiment, the controller 10 is, for example, one or more general purpose processing circuits such as a microprocessor, a microcontroller, and a digital signal processor, or a dedicated processing circuit such as an application-specific integrated circuit (ASIC).

The money handling machine 1 includes a data storage device 19. The data storage device 19 is a nonvolatile storage, such as a memory. The data storage device 19 stores various types of information on the money handling machine 1. The data storage device 19 stores at least the number of coins of each denomination stored in the first storage space 25 and the number of coins of each denomination stored in the second storage unit 18.

The depositing unit 11, the dispensing unit 12, the feeding unit 13, the recognition unit 14, the transport unit 15, and the storage 2 including the second storage unit 18, described above, are housed in a body 101. The money handling machine 1 includes a power supply box 102 behind the body 101. The power supply box 102 functions to supply power to the components in the body 101. The power supply box 102 is arranged parallel to the body 101. This can lower the overall height of the money handling machine 1. The money handling machine 1 with a low overall height is suitable as a desktop money handling machine 1 to be placed on a fixture.

### Money Storage Device

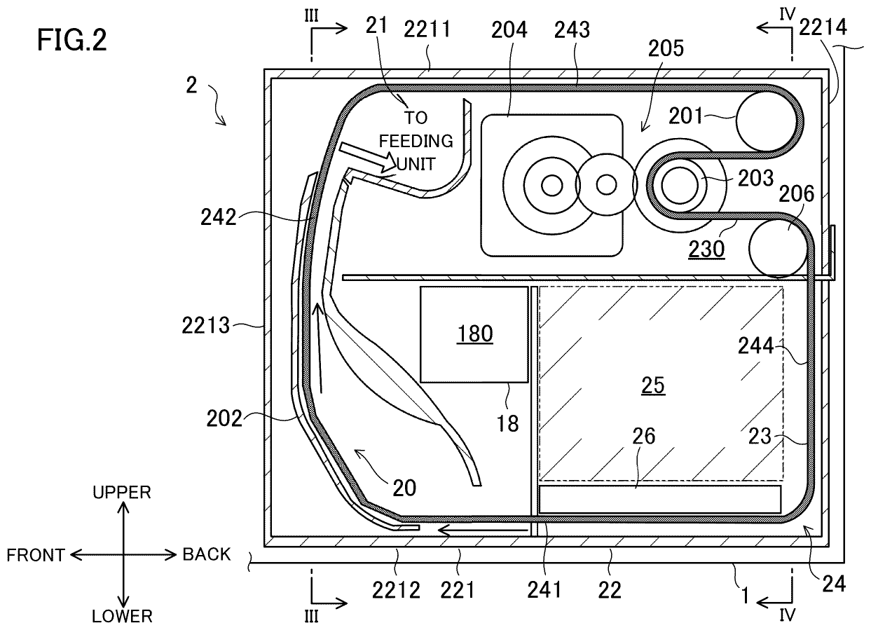

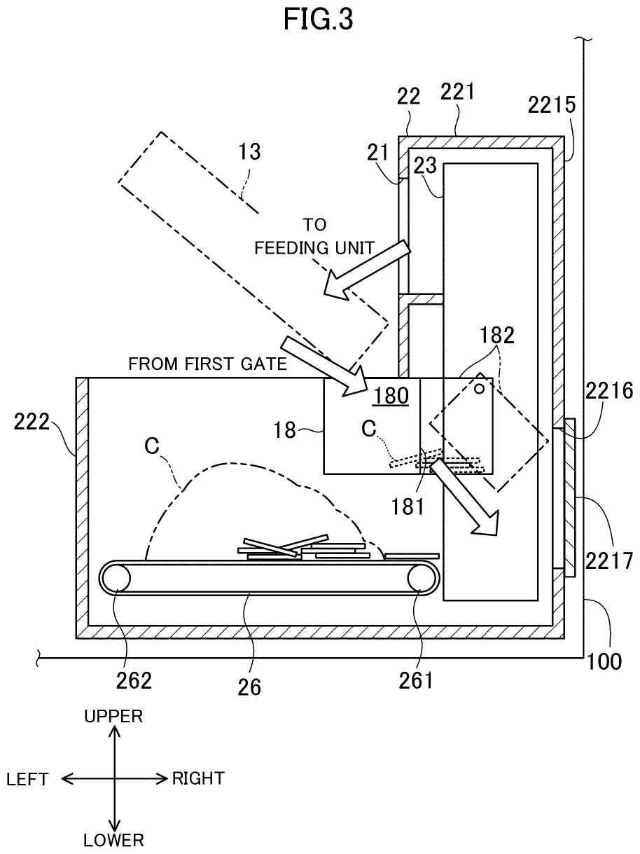

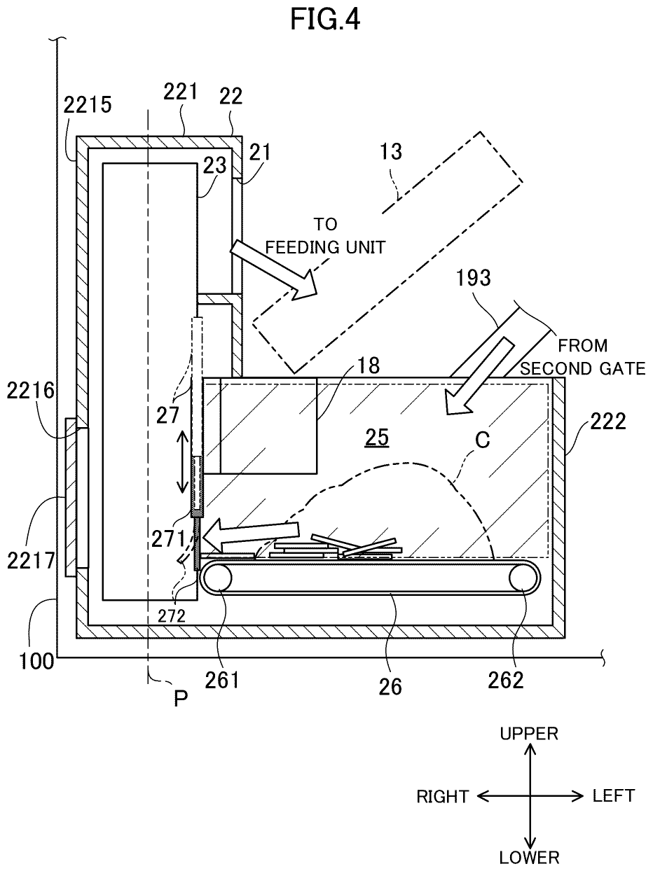

FIG. 2 illustrates an internal structure of the storage 2. FIG. 3 corresponds to a cross section taken along line III-III in FIG. 2, and FIG. 4 corresponds to a cross section taken along line IV-IV in FIG. 2. The storage 2 includes a housing 22. The discharge mechanism 20 is located in the housing 22.

The housing 22 includes a first housing 221 and a second housing 222. The first housing 221 and the second housing 222 are integrated together.

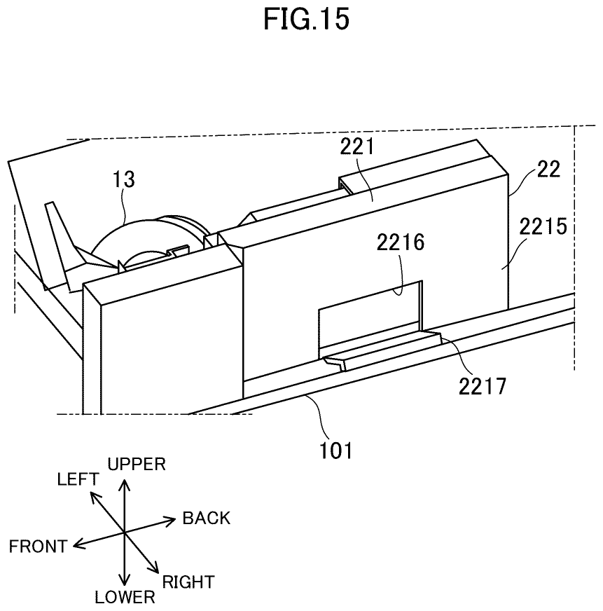

The first housing 221 is located on the right side of the second housing 222. The first housing 221 is located near a side wall 100 of the body 101 (i.e., the housing) of the money handling machine 1 (see also FIG. 15).

As illustrated in FIG. 2, the first housing 221 includes an upper wall 2211, a lower wall 2212, a front wall 2213, and a back wall 2214. The lower wall 2212 faces the upper wall 2211 in the upward/downward direction. The upper wall 2211 and the lower wall 2212 are horizontal walls.

The front wall 2213 is located between the front end of the upper wall 2211 and the front end of the lower wall 2212. The back wall 2214 is located between the back end of the upper wall 2211 and the back end of the lower wall 2212, and faces the front wall 2213 in a forward/backward direction. The front wall 2213 and the back wall 2214 are vertical walls.

The first housing 221 has a quadrangular shape as a whole. The first housing 221 does not have to be in the shape of a perfect quadrangle.

The first housing 221 houses the discharge mechanism 20. The discharge mechanism 20 includes a transport belt 23. As illustrated in FIG. 3 or 4, the transport belt 23 is along a right wall 2215 of the first housing 221. The transport belt 23 is located at the right end, in a leftward/rightward direction, of the interior of the housing 22 including the first housing 221 and the second housing 222.

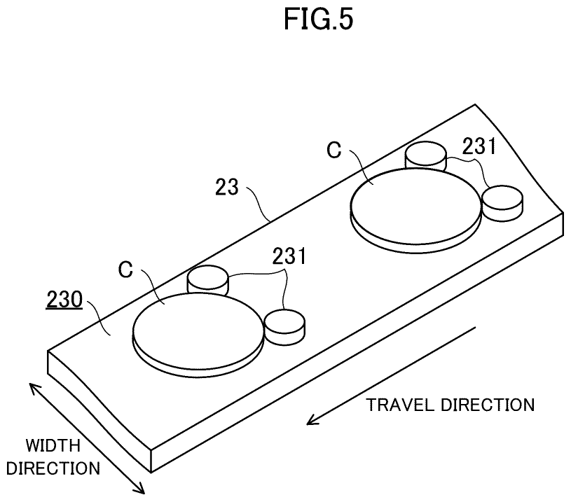

The transport belt 23 is a flexible endless belt. The transport belt 23 transports coins. As illustrated in FIG. 5, the transport belt 23 has protrusions 231 (i.e., pins) protruding from a surface 230 of the transport belt 23. The surface 230 of the transport belt 23 is an inward-facing surface of the transport belt 23 facing inward of the belt path 24, the transport belt 23 revolving in the first housing 221.

Each two of the protrusions 231 spaced apart from each other in the width direction of the transport belt 23 form a pair, and such pairs are arranged at intervals in a direction of travel of the transport belt 23. Coins C are transported while being engaged with the corresponding pairs of protrusions 231. The transport belt 23 can stably transport the coins C even through a vertical or substantially vertical second path 242 as will be described later. The transport belt 23 disengaged from the coins C enables stable discharge of the coins C from the exit 21.

The belt path 24 of the transport belt 23 is defined by pulleys 201, 203, and 206 or a guide 202. The belt path 24 is set along the upper wall 2211, the lower wall 2212, the front wall 2213, and the back wall 2214 of the first housing 221. The transport belt 23 revolves in a vertical plane P (see FIG. 4) spreading in the forward/backward direction and in the upward/downward direction.

The belt path 24 includes a first path 241, the second path 242, a third path 243, and a fourth path 244. The first path 241 extends along the lower wall 2212 at a bottom portion of the interior of the first housing 221. As will be described later, the coins C in the first storage space 25 or the coins C discharged from the second storage unit 18 engage with the transport belt 23 in the first path 241.

The second path 242 is continuous with the first path 241. The second path 242 reaches an upper portion of the first housing 221 from the bottom portion of the first housing 221 along the front wall 2213. The second path 242 lifts the coins C from the bottom portion to the upper portion of the first housing 221.

The exit 21 of the storage 2 opens sideways through the upper portion of the first housing 221. The coins C lifted to the upper portion of the first housing 221 through the second path 242 are discharged to the outside of the storage 2 through the exit 21. The discharged coins C are sent to the feeding unit 13 as indicated by the corresponding hollow arrow in FIG. 3 or 4.

The third path 243 faces the first path 241 in the upward/downward direction. The third path 243 is continuous with the second path 242, and extends backward along the upper wall 2211 in the upper portion of the first housing 221.

The fourth path 244 faces the second path 242 in the forward/backward direction. The fourth path 244 connects the third path 243 and the first path 241 together. The fourth path 244 is located near the back wall 2214. The transport belt 23 is wound on a drive pulley 203 in the fourth path 244. The drive pulley 203 is in contact with the back surface of the transport belt 23, and transmits power that causes the transport belt 23 to travel to the transport belt 23.

The drive pulley 203 is located in the upper portion of the interior of the first housing 221. The upper portion of the interior of the first housing 221 may be the upper one of upper and lower portions into which the interior of the first housing 221 is divided equally in the upward/downward direction.

The drive pulley 203 is coupled to a motor 204 via a gear train 205. The motor 204 and the gear train 205 are located in the upper portion of the interior of the first housing 221. The motor 204 and gear train 205 are also located inside the belt path 24.

The housing 22 forms the first storage space 25 surrounded by the dash-dot-dot line in FIG. 2 or 4. The first storage space 25 stores coins C. The first storage space 25 is formed inside the looped belt path 24 so as to be surrounded by the belt path 24.

The first path 241 and the third path 243 face each other with the first storage space 25 interposed therebetween in the upward/downward direction. The second path 242 and the fourth path 244 face each other with the first storage space 25 interposed therebetween in the horizontal direction.

More specifically, the first storage space 25 is formed below the motor 204 and the gear train 205 and in a back portion of the housing 22. The back portion of the housing 22 may be the back one of front and back portions into which the interior of the housing 22 is divided equally in the forward/backward direction as illustrated in FIG. 2.

The first storage space 25 is defined by a portion of the first housing 221 and the second housing 222. The first housing 221 and the second housing 222 form the single continuous first storage space 25.

The first storage space 25 is connected to the third chute 193. As indicated by the corresponding hollow arrow in FIG. 4, coins C conveyed from the second gate 162 through the third chute 193 are stored in the first storage space 25. The coins C are accumulated at the bottom of the first storage space 25 under their own weights.

The storage 2 includes a second transport belt 26. The second transport belt 26 is located in a bottom portion of the first storage space 25, and is adjacent to the transport belt 23. The second transport belt 26 is wound between two pulleys 261 and 262 spaced apart from each other in the rightward/leftward direction. The second transport belt 26 travels in the rightward/leftward direction, i.e., in a direction orthogonal to the direction of travel of the transport belt 23.

The coins C stored in the first storage space 25 are placed on the second transport belt 26. When the second transport belt 26 travels toward the transport belt 23, the coins C in the first storage space 25 move toward the transport belt 23 in the first path 241. The coins C are delivered from the second transport belt 26 to the transport belt 23. The coins C engage with the corresponding protrusions 231 on the surface 230 of the transport belt 23 in the first path 241.

The storage 2 has a shutter 27. The shutter 27 limits the amount of coins C to be supplied from the second transport belt 26 to the transport belt 23. The shutter 27 includes a body 271, and a curtain 272 serving as a partition.

The curtain 272 is attached to a lower portion of the body 271, and hangs from the lower portion of the body 271. The curtain 272 is interposed between the second transport belt 26 and the transport belt 23. The curtain 272 can be bent in a direction in which the coins C are supplied from the second transport belt 26 to the transport belt 23, i.e., in the leftward/rightward direction (see the dash-dot-dot line in FIG. 4). When coins C are supplied from the second transport belt 26 to the transport belt 23, the curtain 272 pushed by the coins C and bent allows the coins C to be supplied, and keeps a large amount of coins C from being supplied to the transport belt 23 at once.

The body 271 is attached to the housing 22 of the storage 2 so as to be able to reciprocate in the upward/downward direction. The body 271 moving upward causes the curtain 272 to move upward. The gap between the curtain 272 and each of the transport belt 23 and the second transport belt 26 is thus extended. This increases the amount of coins C to be supplied from the second transport belt 26 to the transport belt 23. The amount of coins C to be discharged from the storage 2 per unit time increases. The body 271 moving downward narrows the gap between the curtain 272 and each of the transport belt 23 or the second transport belt 26. This reduces the amount of coins C to be supplied from the second transport belt 26 to the transport belt 23. The amount of coins C to be discharged from the storage 2 per unit time decreases.

The controller 10 positions the shutter 27 at a lower position in a change replenishment process to be described later, for example. The controller 10 positions the shutter 27 at an upper position in a collection process to be described later, for example. The collection process can be quickly completed.

As illustrated in FIG. 2, the second storage unit 18 is located inside the belt path 24. More specifically, the second storage unit 18 is located below the motor 204 and the gear train 205 and above the first path 241 of the transport belt 23 in front of the first storage space 25 in the housing 22.

The second storage unit 18 forms the second storage space 180 closed in the housing 22. The second storage space 180 has a smaller capacity than the first storage space 25 does. The second storage unit 18 is connected to the second chute 192. As indicated by the corresponding hollow arrow in FIG. 3, coins C conveyed from the first gate 161 through the second chute 192 are stored in the second storage space 180.

The second storage unit 18 has a hopper-like structure as illustrated in FIG. 3. The second storage unit 18 has a discharge port 181 that is openable and closable by a swing-type cover 182. As indicated by the corresponding dash-dot-dot line in FIG. 3, when the cover 182 opens the discharge port 181, the second storage space 180 is opened in the housing 22, and the coins C stored in the second storage unit 18 are discharged into the housing 22. The discharged coins C are placed on the transport belt 23 in the first path 241. The coins C discharged from the second storage unit 18 do not enter the first storage space 25. The second storage unit 18 discharges the coins C stored in the second storage space 180 to the transport belt 23 in the first path 241 separately from coins C stored in the first storage space 25.

In the storage 2, both coins C in the first storage space 25 and coins C in the second storage unit 18 can be supplied to the transport belt 23.

The transport belt 23 revolving in the clockwise direction in FIG. 2 allows coins C engaged with the transport belt 23 in the first path 241 to be lifted through the second path 242 and to be transported to the exit 21.

The coins C in the first storage space 25 are smoothly discharged from the exit 21 by a combination of the second transport belt 26 and the transport belt 23. The coins C in the second storage unit 18 are also supplied to the transport belt 23 in the first path 241, and are thus stably discharged from the exit 21.

In the storage 2, the belt path 24 is set along the upper wall 2211, the lower wall 2212, the front wall 2213, and the back wall 2214 of the housing 22. The belt path 24 is designed to extend in the upward/downward direction and in the horizontal direction inside the housing 22 to the extent possible.

Such extension of the loop forming the belt path 24 can enlarge the first storage space 25. This allows the storage 2 to have a sufficiently large capacity even if the housing 22 is compact. In addition, the shape of the belt path 24 corresponds to the quadrangular shape of the first housing 221. This helps enlarge the first storage space 25.

The transport belt 23 transports coins C to the exit 21 formed through an upper portion of the housing 22.

Since the upper portion of the first housing 221 has the exit 21, the upper portion is a space that is hardly used to store coins C. The motor 204 and the gear train 205 are located inside the belt path 24 and in the upper portion of the first housing 221. In other words, the motor 204 and the gear train 205 are arranged in a space that cannot be used as the first storage space 25 inside the belt path 24.

Since the motor 204 and the gear train 205 are located in the upper portion of the first housing 221, a space below the motor 204 and the gear train 205 can be used as the first storage space 25 and the second storage unit 18.

In addition, since the motor 204 and the gear train 205 are located inside the belt path 24, the belt path 24 can be brought closer to the upper wall 2211, the lower wall 2212, the front wall 2213, or the back wall 2214 inside the housing 22. This helps enlarge the first storage space 25.

Further, since the motor 204 is located in the housing 22, there is no need to form a space for arrangement of the motor 204 outside the housing 22. Thus, the space efficiency of the money handling machine 1 is also improved.

As illustrated in FIG. 3 or 4, the transport belt 23 is located at the right end of the interior of the housing 22, which helps enlarge the first storage space 25. Even if the transport belt 23 is located at an end of the interior of the housing 22, the second transport belt 26 transports coins C to the transport belt 23, and thus the coins C stored in the first storage space 25 can be smoothly discharged from the storage 2.

The first storage space 25 and the second storage unit 18 (i.e., the second storage space) are arranged in a direction along the first path 241 of the transport belt 23. Since the two storage spaces are arranged in the horizontal direction, the overall height of the storage 2 can be lowered.

The transport belt 23 transports coins C both from the first storage space 25 and from the second storage unit 18.

The belt path 24 in the storage 2 described above is an example, and can be modified. For example, some of the pulleys may be omitted. The omission of the pulleys triggers a change in the shape of the belt path from the illustrated shape.

### Processes in Money Handling Machine

Next, an operation of the money handling machine 1 will be described with reference to the drawings. As described above, the money handling machine 1 executes at least the process for depositing coins and the process for dispensing coins. The process for depositing coins is a process in which the money handling machine 1 stores coins inserted into the depositing unit 11 in the first storage space 25 of the storage 2. The process for dispensing coins is a process in which the money handling machine 1 dispenses coins to be dispensed as change to a customer out of the second storage unit 18 to the dispensing unit 12.

The second storage unit 18 is a stacker that stores coins to be dispensed in the dispensing process. The second storage unit 18 stores at least a minimum set of coins that minimizes the number of coins required for making change in advance. The minimum set of coins means a combination of the different minimum numbers of coins of different denominations required to accommodate every amount of money serving as change to be paid with coins.

If the money handling machine 1 executes, for example, handling of euro coins, the minimum numbers of two-euro coins, one-euro coins, 0.50 euro coins, 0.20 euro coins, 0.10 euro coins, 0.05 euro coins, 0.02 euro coins, and 0.01 euro coins are two, one, one, two, one, one, two, and one, respectively. The money handling machine 1 makes the second storage unit 18 store coins for change at least before the start of the dispensing process. Thus, the money handling machine 1 executes the change replenishment process for replenishing the second storage unit 18 with coins for change after the execution of the dispensing process.

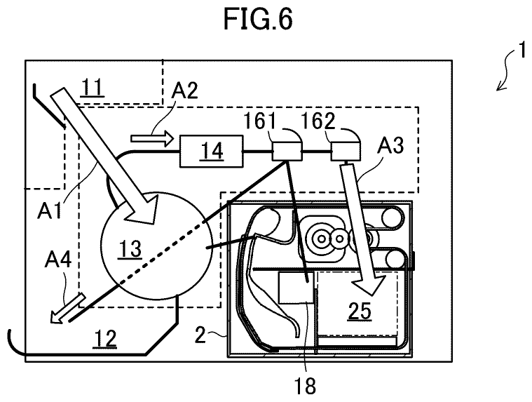

FIG. 6 illustrates a coin transport route in the depositing process. Coins inserted into the depositing unit 11 are sent to the feeding unit 13 as indicated by the arrow A1 in FIG. 6.

The feeding unit 13 feeds out coins one by one to the recognition unit 14 as indicated by the arrow A2. The recognition unit 14 recognizes the denominations of the coins.

The coins that have passed through the recognition unit 14 reach the first gate 161. The first gate 161 allows coins that can be accepted by the money handling machine 1 to pass therethrough toward the second gate 162 based on the recognition result of the recognition unit 14. The acceptable coins are conveyed through the second gate 162 to the first storage space 25 of the storage 2 as indicated by the arrow A3. The first storage space 25 stores a mixture of coins of a plurality of denominations.

The first gate 161 sends coins that are unacceptable by the money handling machine 1 to the dispensing unit 12 as indicated by the arrow A4. The unacceptable coins are returned to the customer.

After the storage 2 completes storing coins, the money handling machine 1 calculates the amount of the deposited coins based on the recognition result of the recognition unit 14.

The data storage device 19 updates and stores the inventory amount in the first storage space 25, based on the denominations of coins stored in the first storage space 25 and the number of coins of each denomination. The inventory amount in the first storage space 25 includes the number of coins of each denomination and the total sum of coins stored in the first storage space 25.

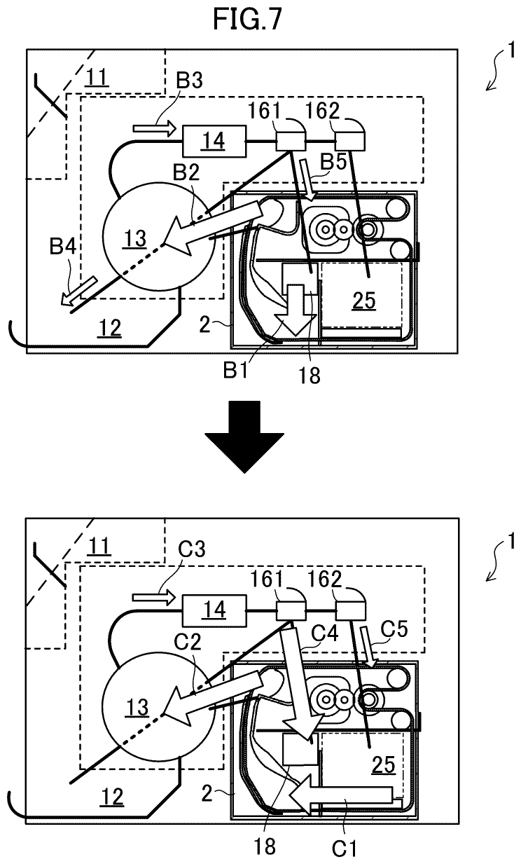

An upper portion of FIG. 7 illustrates a coin transport route in the dispensing process. When receiving a dispensing instruction during the dispensing process, the second storage unit 18 discharges all the stored coins into the storage 2 as indicated by the arrow B1.

The discharge mechanism 20 discharges the coins discharged by the second storage unit 18 out of the storage 2. The discharged coins are sent to the feeding unit 13 as indicated by the arrow B2.

The feeding unit 13 feeds out coins one by one to the recognition unit 14 as indicated by the arrow B3. The recognition unit 14 recognizes the denominations of the coins.

The coins that have passed through the recognition unit 14 reach the first gate 161. The first gate 161 sends coins to be dispensed as change through the first chute 191 to the dispensing unit 12, based on the recognition result of the recognition unit 14 (see the arrow B4). The dispensing unit 12 holds change.

The first gate 161 sends coins that are not to be dispensed through the second chute 192 to the second storage unit 18 as indicated by the arrow B5. The second storage unit 18 stores the returned coins.

When the change is fully dispensed to the dispensing unit 12, the dispensing process is completed. The data storage device 19 updates and stores the inventory amount in the second storage unit 18. The inventory amount in the second storage unit 18 includes the number of coins of each denomination and the total sum of coins stored in the second storage unit 18.

A lower portion of FIG. 7 illustrates a coin transport route in the change replenishment process. After the dispensing process is executed, the money handling machine 1 executes the change replenishment process. The storage 2 supplies coins from the first storage space 25 to the transport belt 23 during the change replenishment process. The discharge mechanism 20 transports coins toward the exit 21 as indicated by the arrow C1. The coins discharged out of the storage 2 are sent to the feeding unit 13 as indicated by the arrow C2.

The feeding unit 13 feeds out coins one by one to the recognition unit 14 (see the arrow C3). The recognition unit 14 recognizes the denominations of the coins.

The coins that have passed through the recognition unit 14 reach the first gate 161. The first gate 161 sends coins with which the second storage unit 18 is to be replenished to the second storage unit 18 as indicated by the arrow C4, based on the recognition result of the recognition unit 14.

The first gate 161 further sends coins with which the second storage unit 18 is not to be replenished to the second gate 162. The coins with which the second storage unit 18 is not to be replenished are returned through the second gate 162 to the first storage space 25 as indicated by the arrow C5.

The storage 2 continues to discharge coins from the first storage space 25 until a minimum set of coins for making change are stored in the second storage unit 18. If a minimum set of coins for making change are stored in the second storage unit 18, the storage 2 terminates the discharge of coins.

The money handling machine 1 includes the first storage space 25 having a relatively large capacity, and the second storage unit 18 having a relatively small capacity. The first storage space 25 and the second storage unit 18 each store a mixture of coins of a plurality of denominations. The storage 2 that stores such a mixture can be more compact than a stacker having the same capacity and storing coins of different denominations in a plurality of different storages.

It may take time for a stacker that stores a mixture of coins of a plurality of denominations to feed out coins of an intended denomination. To address this problem, the money handling machine 1 includes the second storage unit 18 with a small capacity. The second storage unit 18 stores a minimum set of coins for making change. Using the second storage unit 18 enables rapid selection of coins of the intended denomination. Thus, the money handling machine 1 can rapidly complete the process for dispensing change coins.

The number of change coins stored in the second storage unit 18 is not limited to the minimum set of coins for making change. For example, if the number of coins of each of some of the denominations forming a minimum set of the coins is less than a predetermined number, the coins may be replaced with coins of another denomination to constitute change coins.

### Depositing Process in Which Second Storage Unit is Used as Temporary Storage Unit

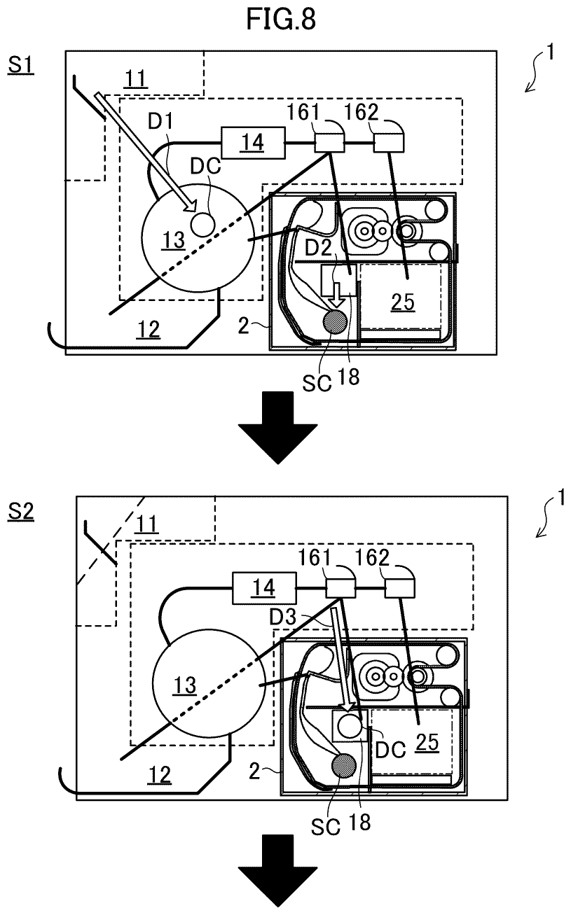

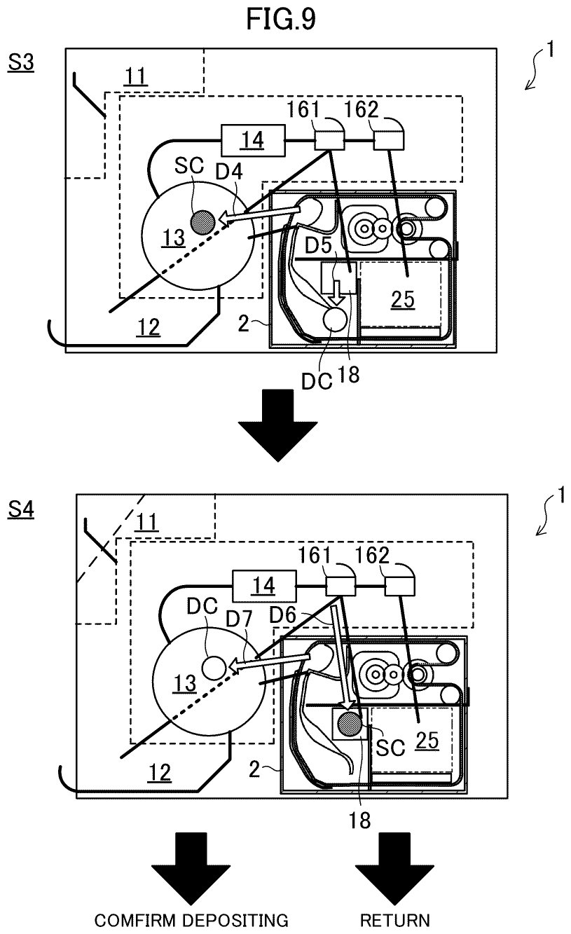

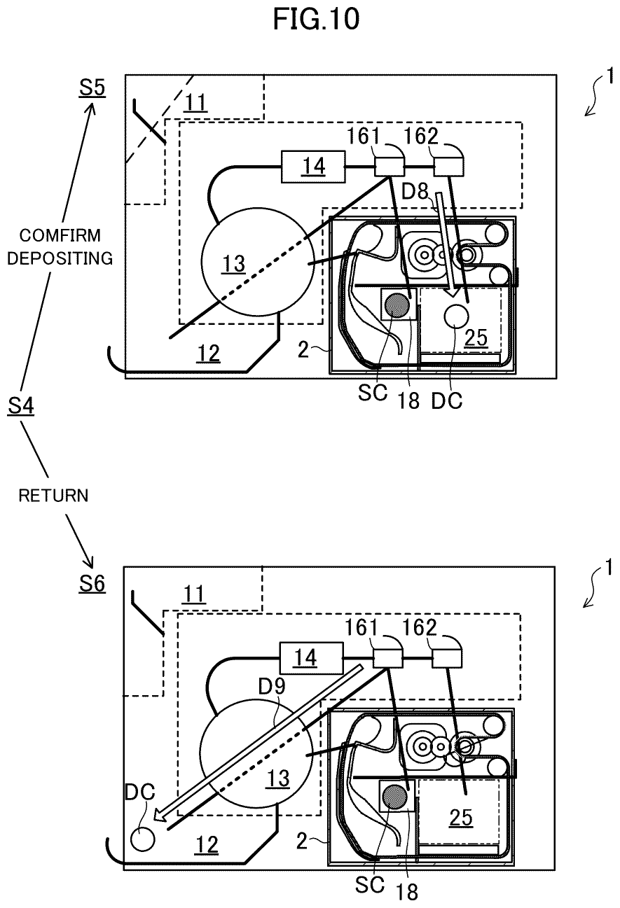

The second storage unit 18 in the storage 2 can be used as the temporary storage unit during the depositing process. The procedure of the depositing process will be described below with reference to FIGS. 8 to 10.

First, in step S1 shown in FIG. 8, as indicated by the arrow D1, deposited coins DC inserted into the depositing unit 11 are conveyed to the feeding unit 13. The second storage unit 18 discharges stored coins SC (stored money) stored as change into the storage 2 as indicated by the arrow D2. The second storage unit 18 becomes empty. Note that the order of the timing of sending the deposited coins DC to the feeding unit 13 and the timing of discharging the stored coins SC may be reversed.

Then, in subsequent step S2, the feeding unit 13 feeds out the deposited coins DC to the recognition unit 14, and recognition unit 14 recognizes the deposited coins DC. The deposited coins DC that have been recognized reach the first gate 161. The first gate 161 sends acceptable ones of the deposited coins DC to the second storage unit 18 that is empty (see the arrow D3). The second storage unit 18 temporarily stores the deposited coins DC. The first gate 161 sends unacceptable ones of the deposited coins DC to the dispensing unit 12. The total sum of the deposited coins DC temporarily stored in the second storage unit 18 is presented to the customer who has performed the depositing process (i.e., the user).

In step S3, the storage 2 discharges the stored coins SC discharged from the second storage unit 18, and sends the discharged coins SC to the feeding unit 13 (see the arrow D4). In addition, the second storage unit 18 discharges the temporarily stored deposited coins DC into the storage 2 (see the arrow D5).

As in step S2, in step S4, the feeding unit 13 feeds out the stored coins SC to the recognition unit 14, and the recognition unit 14 recognizes the stored coins SC. The recognition to be performed by the recognition unit 14 may be omitted. The stored coins SC that have passed through the recognition unit 14 are conveyed through the first gate 161 to the second storage unit 18 (see the arrow D6).

In step S4, the storage 2 discharges the deposited coins DC discharged from the second storage unit 18, and sends the discharged deposited coins DC to the feeding unit 13 (see the arrow D7).

The customer who has performed the depositing process performs an operation for confirming a deposit or for cancelling a deposit. If the money handling machine 1 receives the confirmation operation, the feeding unit 13 feeds out the deposited coins DC to the recognition unit 14 in step S5. The deposited coins DC that have passed through the recognition unit 14 are conveyed through the first gate 161 and the second gate 162 to the first storage space 25 of the storage 2 (see the arrow D8).

If the money handling machine 1 receives the cancellation operation, the feeding unit 13 feeds out the deposited coins DC to the recognition unit 14 in step S6. The deposited coins DC that have passed through the recognition unit 14 are conveyed through the first gate 161 to the dispensing unit 12 (see the arrow D9).

Even if the second storage unit 18 is used as the temporary storage unit during the depositing process, coins SC for change are stored in the second storage unit 18 as before the start of the depositing process. The money handling machine 1 can rapidly perform the dispensing process after the depositing process.

### Circulation Transport During Depositing Process

In the depositing process illustrated in FIG. 6, the coins determined by the recognition unit 14 to be unacceptable are conveyed through the first gate 161 to the dispensing unit 12.

The second storage unit 18 may be used for the dispensing process to allow the recognition unit 14 to perform re-recognition.

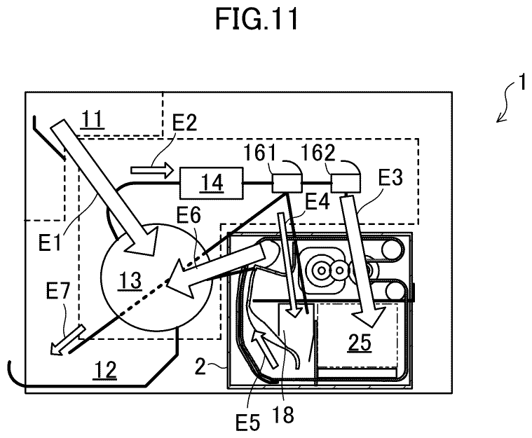

FIG. 11 illustrates a coin transport route in the depositing process. Before the start of the depositing process, the second storage unit 18 is emptied, and coins located on the transport belt 23 and including the coins discharged from the second storage unit 18 are stored in the first storage space 25.

Coins inserted into the depositing unit 11 are sent to the feeding unit 13 as indicated by the arrow E1 in FIG. 11.

The feeding unit 13 feeds out coins one by one to the recognition unit 14 as indicated by the arrow E2. The recognition unit 14 recognizes the denominations of the coins.

The coins that have passed through the recognition unit 14 reach the first gate 161. The first gate 161 allows coins that can be accepted by the money handling machine 1 to pass therethrough toward the second gate 162 based on the recognition result of the recognition unit 14. The acceptable coins are conveyed through the second gate 162 to the first storage space 25 of the storage 2 as indicated by the arrow E3. The first storage space 25 stores a mixture of coins of a plurality of denominations.

The first gate 161 sends coins that are unacceptable by the money handling machine 1 to the second storage unit 18 as indicated by the arrow E4.

The discharge port 181 of the second storage unit 18 may be opened or closed. If the discharge port 181 is opened, the coins sent to the second storage unit 18 are discharged through the second storage unit 18 to the transport belt 23. If the discharge port 181 is closed, the discharge port 181 is opened at an appropriate timing. The coins sent to the second storage unit 18 are then discharged through the second storage unit 18 to the transport belt 23.

After all the coins inserted into the depositing unit 11 are fed out from the feeding unit 13, the discharge mechanism 20 transports the coins discharged to the transport belt 23 to the exit 21 so as to be discharged out of the storage 2 as indicated by the arrow E5. The coins discharged from the exit 21 are sent to the feeding unit 13 as indicated by the arrow E6.

If the coins that have circulated through the second storage unit 18 are sent to the feeding unit 13, the feeding unit 13 feeds out the coins to the recognition unit 14 again as indicated by the arrow E2. The recognition unit 14 recognizes the denominations of the coins. The re-recognition allows the coins that can be accepted by the money handling machine 1 to be conveyed through the second gate 162 to the first storage space 25 of the storage 2 as indicated by the arrow E3.

The re-recognition may further allow the coins that are unacceptable by the money handling machine 1 to be conveyed through the first gate 161 to the dispensing unit 12 as indicated by the arrow E7.

Even if the transport path 16 does not have a folded portion, using the second storage unit 18 allows the money handling machine 1 to circulate and transport coins in the depositing process. Performing recognition a plurality of times can enhance the accuracy with which the money handling machine 1 recognizes coins.

### Circulation Transport During Dispensing Process

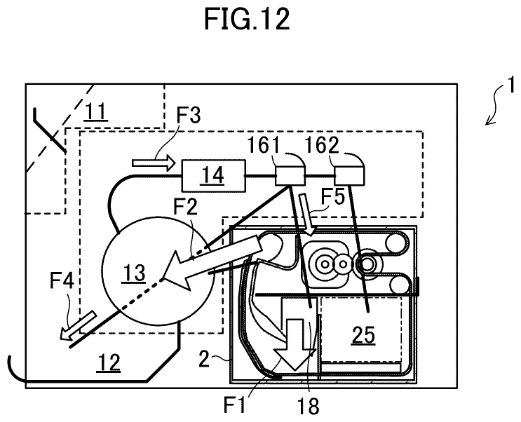

During the dispensing process, coins may be circulated and transported through the second storage unit 18. FIG. 12 illustrates a coin transport route in the dispensing process. When receiving a dispensing instruction during the dispensing process, the second storage unit 18 discharges all the stored coins into the storage 2 as indicated by the arrow F1. The discharge port 181 of the second storage unit 18 remains open during the dispensing process.

The discharge mechanism 20 discharges the coins discharged by the second storage unit 18 out of the storage 2. The discharged coins are sent to the feeding unit 13 as indicated by the arrow F2.

The feeding unit 13 feeds out coins one by one to the recognition unit 14 as indicated by the arrow F3. The recognition unit 14 recognizes the denominations of the coins.

The coins that have passed through the recognition unit 14 reach the first gate 161. The first gate 161 sends coins to be dispensed as change through the first chute 191 to the dispensing unit 12, based on the recognition result of the recognition unit 14 (see the arrow F4). The dispensing unit 12 holds change.

The first gate 161 sends coins that are not to be dispensed through the second chute 192 to the second storage unit 18 as indicated by the arrow F5. The coins sent to the second storage unit 18 include coins recognized not to be dispensed and coins determined to be rejected coins without being accurately recognized by the recognition unit 14, for example.

The coins sent to the second storage unit 18 are discharged through the opened discharge port 181 to the transport belt 23. The discharge mechanism 20 again discharges the coins discharged to the transport belt 23 out of the storage 2. The discharged coins are sent to the feeding unit 13 as indicated by the arrow F2. The feeding unit 13 again feeds out coins to the recognition unit 14 as indicated by the arrow F3. The recognition unit 14 can re-recognize the denominations of the coins.

Even if the transport path 16 does not have a folded portion, using the second storage unit 18 allows the money handling machine 1 to circulate and transport coins in the dispensing process. Performing recognition a plurality of times can enhance the accuracy with which the money handling machine 1 recognizes coins.

### Switching of Collection Process

The overall height of the money handling machine 1 is lowered. As illustrated in FIG. 1, the transport path 16 connected to the feeding unit 13 extends backward from a front portion of the body 101.

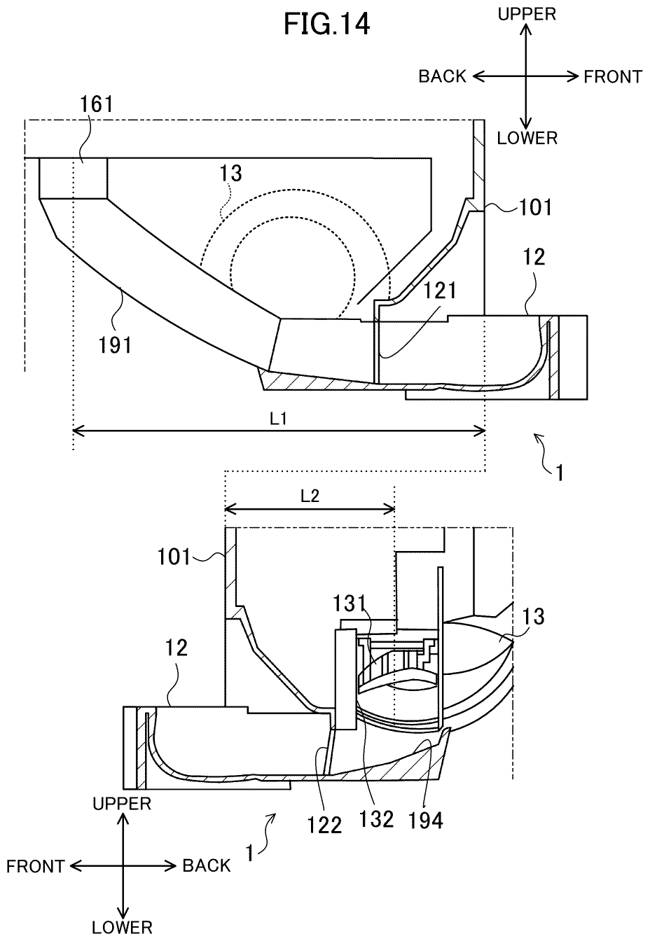

FIG. 13 illustrates the front portion of the body 101 of the money handling machine 1. An upper portion of FIG. 14 illustrates a cross section taken along line A-A in FIG. 13, and a lower portion of FIG. 14 illustrates a cross section taken along line B-B in FIG. 13. As illustrated in the upper portion of FIG. 14, the distance L1 from the first gate 161 to the dispensing unit 12 in the forward/backward direction is long. The first chute 191 connecting the first gate 161 and the dispensing unit 12 together extends long from a back portion to the front portion of the body 101. The first chute 191 is connected to a first exit 121 of the dispensing unit 12.

During the collection process in which coins stored in the storage 2 are dispensed out of the money handling machine 1, the money handling machine 1 operates as follows. Specifically, (A) the storage 2 sends coins in the first storage space 25 or in the second storage unit 18 from the storage 2 to the feeding unit 13. (B) The feeding unit 13 feeds out the coins from the storage 2 to the recognition unit 14, and the recognition unit 14 performs recognition. (C) After the recognition performed by the recognition unit 14, the money handling machine 1 dispenses the coins to the dispensing unit 12 through the first gate 161 and the first chute 191. The collection process is executed by a staff member of a store where the money handling machine 1 is installed or a cash-in-transit (CIT) staff member.

During a total collection process in which all the coins stored in the storage 2 are collected, a large amount of coins move from the feeding unit 13 through the first gate 161 and the first chute 191 to the dispensing unit 12. The first chute 191 being long may prevent coins from moving smoothly during the total collection process.

The money handling machine 1 can execute a selected one of two types of collection processes such as a first collection process and a second collection process. The first collection process is a collection process of performing the steps (A) to (C) described above. The second collection process is a collection process in which a structure for removing a foreign object from the feeding unit 13 is used.

As illustrated in the lower portion of FIG. 14, the feeding unit 13 has an opening/closing portion 131 inside the housing of the money handling machine 1. The opening/closing portion 131 is fitted to the periphery of the rotary-disk feeding unit 13 obliquely inclined, and opens and closes a lower opening 132 formed at the periphery of the feeding unit 13. If a foreign object is present in the feeding unit 13, the lower opening 132 opens to enable discharge of the foreign object out of the feeding unit 13.

A fourth chute 194 continuous with the dispensing unit 12 is connected to the lower opening 132 of the feeding unit 13. The fourth chute 194 is connected to a second exit 122 of the dispensing unit 12. As illustrated in FIG. 13, the second exit 122 is aligned with the first exit 121 in the leftward/rightward direction. The foreign object discharged from the feeding unit 13 reaches the dispensing unit 12 through the fourth chute 194.

The second collection process is the process of dispensing coins from the feeding unit 13 through the fourth chute 194 to the dispensing unit 12. Specifically, in the second collection process, (a) the storage 2 sends coins in the first storage space 25 or in the second storage unit 18 from the storage 2 to the feeding unit 13. (b) The lower opening 132 of the feeding unit 13 opens to allow coins from the storage 2 to be dispensed through the fourth chute 194 to the dispensing unit 12.

Since the feeding unit 13 is located in the front portion of the body 101 of the money handling machine 1, the distance L2 from the feeding unit 13 to the dispensing unit 12 is shorter than the distance L1. In addition, since the size of the lower opening 132 is large, a large amount of coins can be stably and rapidly discharged from the feeding unit 13 to the dispensing unit 12 without causing a jam or any other similar problem. The second collection process is a process in which priority is given to a reduction in the collection time.

Meanwhile, in the second collection process, coins do not pass through the recognition unit 14, and thus the coins cannot be recognized. The denominations and number of the collected coins cannot be checked.

In the first collection process, coins pass through the recognition unit 14. Thus, the denominations and number of the collected coins can be checked. The first collection process is a process in which priority is given to control over the number of the coins immediately after the collection.

The money handling machine 1 may use the first collection process and the second collection process properly as follows. For example, if the number of coins to be collected is less than the preset number of coins, and no error occurs in the money handling machine 1, the first collection process is executed.

For example, if an error has occurred in the money handling machine 1, and the number of coins stored in the storage 2 is indefinite, or if the storage 2 has been directly replenished with coins as will be described later, the money handling machine 1 executes the second collection process.

If the above-described conditions are not matched, and the first collection process and the second collection process can be both executed, the money handling machine 1 causes an operator who instructs the money handling machine 1 to execute the collection process to select the first collection process or the second collection process.

Since the money handling machine 1 can execute the second collection process, jams during the collection process can be reduced, and the time during which the collection process is executed can be shortened. In addition, since the money handling machine 1 switches between the first collection process and the second collection process, the collection process is optimized.

### Structure for Accelerating Replenishment Process and Collection Process

Since the money handling machine 1 is compact, the depositing unit 11 and the dispensing unit 12 have a small size. A replenishment process for replenishing the interior of the storage 2 with coins is performed through insertion of coins for replenishment through the depositing unit 11 into the money handling machine 1. Since the depositing unit 11 has a small size, a long time and effort are required to replenish the storage 2 with a large amount of coins.

In the collection process, as described above, the collected coins are dispensed to the dispensing unit 12. Since the dispensing unit 12 has a small size, a long time and effort are required to collect a large amount of coins.

The money handling machine 1 has a structure that allows the storage 2 to be directly replenished with coins and that allows coins to be collected directly from the storage 2.

FIG. 15 illustrates a state where the body 101 of the money handling machine 1 is pulled out from a casing. The right wall 2215 of the housing 22 of the storage 2 (see also FIG. 3 or 4) is exposed at a right side portion of the body 101 pulled out from the casing.

The right wall 2215 has a communication opening 2216. The communication opening 2216 allows the inside and outside of the housing 22 to communicate with each other. A lid 2217 is attached to the communication opening 2216. The lid 2217 closes the communication opening 2216.

Opening the communication opening 2216 allows the operator to access the interior of the first housing 221 through the communication opening 2216.

If the storage 2 is directly replenished, the operator performing a necessary operation using an input/output device allows the money handling machine 1 to be unlocked. The body 101 can be pulled out from the casing. The operator pulls the body 101 out from the casing, and opens the communication opening 2216. The operator manually inserts coins for replenishment through the communication opening 2216 into the housing 22. Coins are supplied to the first path 241 of the transport belt 23.

After the replenishment with coins, the operator closes the communication opening 2216, and pushes the body 101 into the casing. If the body 101 is placed in the casing, the money handling machine 1 drives the discharge mechanism 20 of the storage 2 to send the supplied coins from the storage 2 to the feeding unit 13 through the transport belt 23. The feeding unit 13 feeds out the coins to the recognition unit 14, and the recognition unit 14 recognizes the coins. The first gate 161 and the second gate 162 each send the coins to a corresponding one of the second storage unit 18 and the first storage space 25 in accordance with the recognition result.

If collection is performed directly from the storage 2, the operator performing a necessary operation using the input/output device allows the money handling machine 1 to drive the second transport belt 26 in the storage 2 to send money in the first storage space 25 to the first path 241 of the transport belt 23. The second storage unit 18 opens the discharge port 181 to discharge coins to the first path 241 of the transport belt 23.

If coins are sent to the first path 241 of the transport belt 23, the money handling machine 1 is unlocked. The body 101 can be pulled out from the casing. The operator pulls the body 101 out from the casing, and opens the communication opening 2216. The operator manually takes the coins accumulated near the first path 241 of the transport belt 23 in the housing 22 out of the housing 22 through the communication opening 2216.

After the collection of coins, the operator closes the communication opening 2216, and pushes the body 101 into the casing.

The collection from the storage 2 is not limited to the collection of all the coins in the storage 2, and may be collection of some of the coins.

### Variation of Depositing Unit

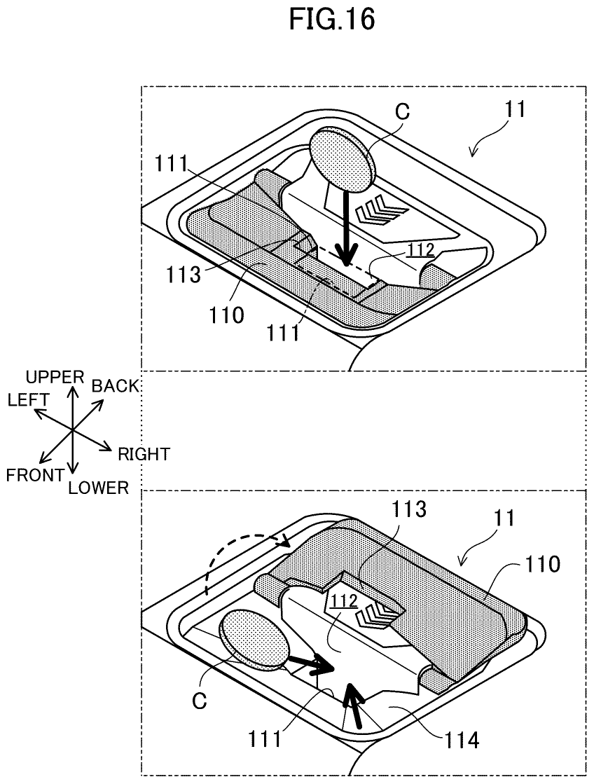

FIG. 16 illustrates a variation of the depositing unit 11. A depositing unit 11 according to the variation includes a slot cover 110. The slot cover 110 switches the size of a slot 111 for coins between a large size and a small size. An upper portion of FIG. 16 illustrates a state where the slot cover 110 has been mounted on the slot 111 to reduce the size of the slot 111. A lower portion of FIG. 16 illustrates a state where the slot cover 110 has been detached from the slot 111 to increase the size of the slot 111. The dash-dot-dot line in the upper portion of FIG. 16 indicates the size of the slot 111 from which the slot cover 110 has been detached. The slot 111 is rectangular in plan view.

As illustrated in the upper portion or the lower portion of FIG. 16, a portion of the slot 111 is defined by a vertical surface 112. The vertical surface 112 corresponds to one side of the slot 111, and extends downward from the slot 111.

The slot cover 110 is attached to the housing of the money handling machine 1. The slot cover 110 has a limiting portion 113. The limiting portion 113 is inserted into the slot 111 to reduce the size of the slot 111. The limiting portion 113 inserted into the slot 111 does not cover the vertical surface 112.

As illustrated in the upper portion of FIG. 16, the slot 111 that has its size reduced has a size large enough to allow a vertically oriented coin C to pass therethrough. During the depositing process of the money handling machine 1, the slot cover 110 is mounted on the slot 111. The user inserts a small number of coins C, such as one to several coins, into the slot 111. The vertical surface 112 can guide the coins C downward from the slot 111 even with the slot cover 110 mounted on the slot 111. The vertical surface 112 guiding the vertically oriented coin C can reduce jams of the coin C in the slot 111 during the depositing process of the money handling machine 1.

The slot cover 110 can turn about an axis extending in the horizontal direction. When the slot cover 110 mounted on the slot 111 as illustrated in the upper portion of FIG. 16 is reversely rotated as illustrated in the lower portion of FIG. 16, the limiting portion 113 is detached from the slot 111 to increase the size of the slot 111. In addition, a tray 114 of the depositing unit 11 is opened.

The tray 114 is formed on the housing of the money handling machine 1. The tray 114 has a surface inclined obliquely downward toward the slot 111 around the slot 111. The inclined surface is continuous with three of the four sides of the slot 111 except the other side corresponding to the vertical surface 112.

During the replenishment process of the money handling machine 1, the slot cover 110 is detached from the slot 111 as illustrated in the lower portion of FIG. 16. The operator can insert many coins C into the slot 111 along the surface of the tray 114. The vertical surface 112 guides the coins C downward from the slot 111. One side of the slot 111 configured as the vertical surface 112 reduces jams of the coins C guided along the surface of the tray 114 in the slot 111. The vertical surface 112 reducing jams in the slot 111 eliminates the need for sharply increasing the size of the slot 111. Since the size of the slot 111 from which the slot cover 110 has been detached is not excessively large, a shutter mechanism to be attached to the slot 111 is miniaturized. Miniaturization of the shutter mechanism helps miniaturize the money handling machine 1. The shutter mechanism is a shutter that opens and closes the slot 111 inside the depositing unit 11.

The slot cover 110 illustrated in FIG. 16 switches between a state where it is manually fitted to the slot 111 and a state where it is manually detached from the slot 111. The slot cover 110 may switch between a state where it is electrically fitted to the slot 111 and a state where it is electrically detached from the slot 111, for example.

The slot cover 110 may be detachable from the depositing unit 11. The operator may detach the slot cover 110 from the depositing unit 11 during the replenishment process of the money handling machine 1, and may again fit the slot cover 110 to the depositing unit 11 after completion of the replenishment process.

The depositing unit 11 may include a lock mechanism for the slot cover 110. A user who performs the depositing process (i.e., a customer of the store) is substantially prevented from accidentally or intentionally detaching the slot cover 110 from the slot 111. The operator can detach the slot cover 110 from the slot 111 after unlocking the slot cover 110.

What is claimed is:

1. A money storage device, comprising:
a housing comprising a first storage space in which money is stored;
a second storage unit that is located in the housing and that forms a second storage space independent of the first storage space; and
an endless transport belt that transports the money stored in the first storage space to an exit of the housing, wherein
the transport belt revolves in a vertical plane along an inner wall of the housing that surrounds the first storage space in the housing,
the second storage unit is inside a belt path of the transport belt and discharges money stored in the second storage space into the housing, and
the transport belt transports the money discharged from the second storage unit to the exit.

2. The money storage device of claim 1, wherein
the exit is located in an upper portion of the housing, and
the transport belt transports money from a bottom portion of the housing to the exit.

3. The money storage device of claim 2, wherein
the belt path includes a first path extending along a bottom of the housing,
the money stored in the first storage space is supplied on the transport belt in the first path, and
the second storage unit has an openable/closable discharge port that is opened to discharge the money stored in the second storage space on the transport belt in the first path.

4. The money storage device of claim 3, wherein
the first storage space and the second storage space are arranged in a direction along the first path.

5. The money storage device of claim 3, further comprising:
a second transport belt that is located in the first storage space and is configured to transport money stored in the first storage space toward the transport belt in the first path.

6. The money storage device of claim 5, further comprising:
a shutter that is located between the transport belt and the second transport belt and configured to limit an amount of money to be supplied from the first storage space to the transport belt.

7. The money storage device of claim 3, wherein
the belt path includes a second path that is continuous with the first path and that reaches an upper portion of the housing from the bottom portion of the housing along a vertical inner wall of the housing.

8. The money storage device of claim 1, wherein
a motor that causes the transport belt to travel is located inside the belt path.

9. The money storage device of claim 8, wherein
the motor is located inside the belt path and above the second storage unit.

10. The money storage device of claim 1, wherein
the first storage space stores money of a plurality of denominations, and
the second storage space stores money of a plurality of denominations.

11. A money handling machine, comprising:
the money storage device of claim 1;
a transport unit that is located above the money storage device and transports money;
a feeding unit that is connected to the transport unit and feeds out held money one by one to the transport unit;
a recognition unit that is located at an intermediate position of a transport path of the transport unit and recognizes the money fed out from the feeding unit; and
a diverter that is located at an intermediate position of the transport path and changes a transport destination of money that has passed through the recognition unit in accordance with a recognition result, wherein
money discharged out of the housing from the exit of the housing through the transport belt of the money storage device is sent to the feeding unit.

12. The money handling machine of claim 11, wherein
during a depositing process in which money is stored in the first storage space, the second storage unit discharges stored money stored in the second storage space into the housing of the money storage device,
while the feeding unit feeds out deposited money inserted into the money handling machine during the depositing process to the recognition unit, the diverter sends the deposited money that has been recognized to the second storage unit, and
the second storage unit temporarily stores the deposited money.

13. The money handling machine of claim 12, wherein
in response to an operation for confirming a depositing process, the transport belt of the money storage device transports the stored money discharged from the second storage unit to the exit of the housing to send the stored money to the feeding unit,
after the stored money is sent to the feeding unit, the second storage unit discharges the deposited money stored in the second storage space into the housing,
while the feeding unit feeds out the stored money to the recognition unit, the diverter returns the stored money that has been recognized to the second storage unit,
after the stored money is returned to the second storage unit, the transport belt transports the deposited money discharged from the second storage unit to the exit of the housing to send the deposited money to the feeding unit, and
while the feeding unit feeds out the deposited money to the recognition unit, the diverter sends the deposited money that has been recognized to the first storage space.

14. The money handling machine of claim 12, wherein
in response to an operation for cancelling a depositing process, the transport belt of the money storage device transports the stored money discharged from the second storage unit to the exit of the housing to send the stored money to the feeding unit,
after the stored money is sent to the feeding unit, the second storage unit discharges the deposited money stored in the second storage space into the housing,
while the feeding unit feeds out the stored money to the recognition unit, the diverter returns the stored money that has been recognized to the second storage unit,
after the stored money is returned to the second storage unit, the transport belt transports the deposited money discharged from the second storage unit to the exit of the housing to send the deposited money to the feeding unit, and
while the feeding unit feeds out the deposited money to the recognition unit, the diverter sends the deposited money to a dispensing unit that dispenses money out of the machine.

15. A money handling method, comprising:
transporting money stored in a first storage space in a housing of a money storage device to an exit of the housing through a transport belt in the housing, and discharging the money from the housing;
sending, by a feeding unit, the money discharged from the housing one by one to a recognition unit, and recognizing, by the recognition unit, the money;
sending a designated number of money of a previously designated one or more of denominations to a second storage space of a second storage unit in the housing, based on a recognition result, to store the money in the second storage unit;
discharging all the money stored in the second storage unit into the housing under a dispensing instruction, and transporting, by the transport belt, the money to the exit to discharge the money from the housing;
sending, by the feeding unit, the money discharged from the housing one by one to the recognition unit, and recognizing, by the recognition unit, the money; and
selectively sending money to be dispensed to a dispensing unit, based on a recognition result.
